(19) United States
(12) Patent Application Publication
(10) Pub. No.: US 2007/0073646 A1
(43) Pub. Date: Mar. 29, 2007

(54) User profiler

(75) Inventors: Konagi Uchibe, Machida (JP); Hiroyuki Kumai, Kunitachi (JP); Yasutsugu Morimoto, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/489,570

(22) Filed: Jul. 20, 2006

(30) Foreign Application Priority Data
Sep. 28, 2005 (JP) 2005-281085

(51) Int. Cl. G06F 17/30

(52) U.S. Cl. 707/2

(57) ABSTRACT

In a user profiler used for program recommendation, a user profile which differs particularly according to the season is extracted, saved and appropriately re-used. For this purpose, there are provided a user profiler which extracts user profiles based on program information and a user's view history, and a profile memory which incrementally saves the profiles in a time series based on time information acquired from a timer in the user profiles. The profile memory generates and saves total profile information which is obtained by summing the profiles to be saved for predetermined periods. A total profile memory is also provided which saves the total profile information for these periods when a fixed time has elapsed, and the total profile information which was saved by the total profile memory is re-saved by the profile memory at a certain specified time.

### CLAIM OF PRIORITY

The present application claims priority from Japanese Application JP No. 2005-281085 filed on Sep. 28, 2005, the content of which is hereby incorporated by reference into this application.

### FIELD OF THE INVENTION

The present invention relates to a device which extracts a user profile from program information and a user's view history in order to recommend a TV program corresponding to the user profile to the user.

### BACKGROUND OF THE INVENTION

As the number of TV channels increases, it is becoming more difficult for a user to select a favorite program from the plethora of program information published in newspapers and EPG (electronic program guides).

For this purpose, a user profile can be extracted more precisely using program information in the EPG (electronic program guide) and the user's view history. A technique has been disclosed which, to display a suitable program to the user, calculates profile elements (title, keywords appearing in the program description, type, transmission time slot, channel, etc.) and a user preference rate (profile strength for these elements) with good precision. The main techniques are a technique which deals with profile changes, and a technique which makes use of the way the user watches TV (operations performed while viewing).

One technique which deals with user preference changes calculates the user preference rate according to a profile element group (type, keyword, etc.) or individual profiles, calculates a preference rate for the long-term and short-term respectively, and calculates the profile change from both viewpoints (e.g., JP 2005-85366 A).

The technique which considers how the user watches TV, calculates a profile from the ratio of view time to program transmission time, and the operations performed by the user while viewing (e.g., changing the channel) together with their frequency (e.g., JP 2003-23589 A).

### SUMMARY OF THE INVENTION

In a user's profile, there are many profile elements which are highly dependent on the period or season of the year. One example is a sport performed only at a certain specific time.

In JP 2005-85366 A, the preference rate for a profile element is calculated for every period, and a profile is thereby generated. As to the long-term profile, the preference rate is updated at a leisurely pace, and an attempt is made to reflect long-term profiles. However, compared to programs which are transmitted constantly all the year round and viewed continuously, the preference rate for profile elements of programs transmitted only at certain fixed times decreases with decrease in view frequency. In the short-term, this tendency is still stronger. Therefore, the preference rate of a profile element which has a highly seasonal nature cannot be completely known.

A user's profile continuity is reflected in user operation information during program viewing. For example, this corresponds to channel changing frequency or the view time of each channel. In the device of JP 2003-23589 A, the calculated preference rate takes account of the effect of operations on the profile, e.g., by supposing that it is weak when there is a high channel changing frequency during program viewing, but continuous view time is not taken into consideration. Hence, if programs of the same length are viewed for the same lengths of time, and the channel changing frequency during viewing is the same, the preference rate is the same, and the difference in profile due to the length of continuous view time cannot be computed.

The essential features of the invention as disclosed herein are as follows. A user profiler according to the invention extracts user profiles based on program information and the user's view history. The profiles are saved incrementally in a time series based on time information in the profiles. The saved profiles are summed at predetermined times, and total profile information is thereby generated and saved. Also, in user profiling based on program information and the user's view history, the user preference rate is computed using the ratio of view time for programs viewed intermittently to the transmission time, and matched with words obtained from the program information so as to extract a profile.

By storing and using a profile for predetermined periods, the latest user profile and a user profile which matches the period when profiling is performed, can be extracted for profile elements which are highly seasonal in nature.

### BRIEF DESCRIPTION OF THE DRAWINGS

FIG. 1 is a diagram of the construction of one embodiment of the invention;

FIG. 2 is a diagram showing an example of the construction of profile information;

FIG. 3 is a diagram showing an example of the construction of total profile information;

FIG. 4 is a diagram showing a view history;

FIG. 5 is a diagram showing an example of a user interface for checking re-save of total profile information; and

FIG. 6 is a diagram showing an example of a save processing flow of total view information.

### DETAILED DESCRIPTION OF THE PREFERRED EMBODIMENTS

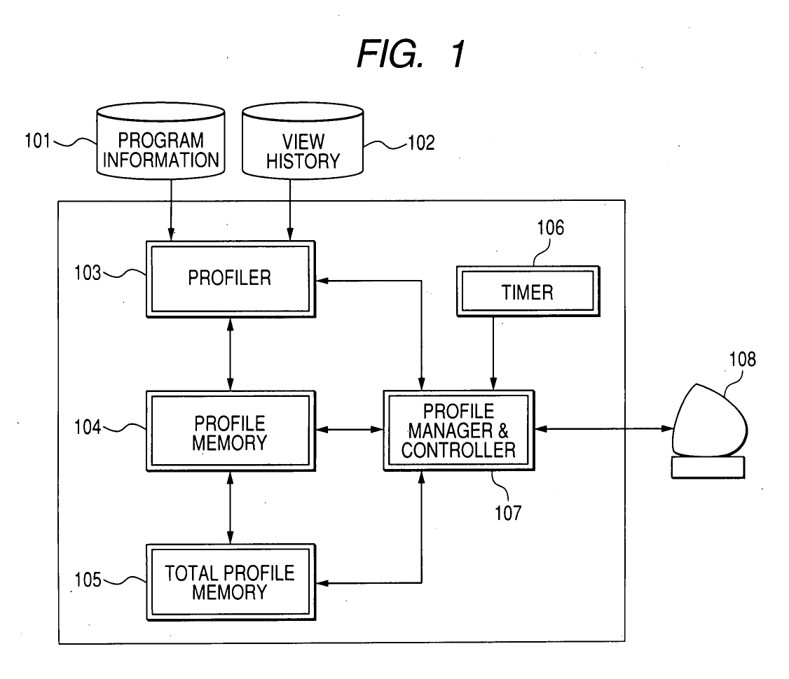

FIG. 1 is a diagram showing a user profiler according to one embodiment of the invention. This embodiment has the feature that when a user's profile is extracted, a profile which is highly seasonal can be correctly reflected by taking the time factor and view duration into consideration.

This device has the following construction. It comprises a user profiler 103, profile memory 104, total profile memory 105, timer 106, profile manager/controller 107 and user interface 108. These may consist of an external storage such as a memory or HDD, real-time clock, microprocessor, console and keyboard which are provided to a computing device such as a personal computer. The operation of each part of the invention may be implemented by software, such as a program module which is installed and run on a computing device such as the personal computer mentioned above. It will of course be understood that the invention is not limited to a personal computer, and may be implemented also by appliances with built-in computers having an identical construction such as TVs, hard disk recorders and portable data terminals.

Hereafter, the various parts of this embodiment of the invention will be described. The user profiler 103 extracts a user profile from electronic data in the program information 101 and electronic data in the view history 102, such as the programs viewed by the user, view times and programs recorded. The program information 101 is data such as the program title, type, performer name and program outline, etc., in an EPG received by a TV set or an Internet EPG obtained via a network. The view history 102 is data concerning the operation history of the TV set or recording device which has been recorded and saved. The operation history monitors a signal value generated in the event of an operation, and records it sequentially. The user profiler 103 extracts words using language processing such as morphological analysis which is a known means, on text information such as the program title, type and performer name which constitute the program information 101, and the program outline in the program information 101. The strength (preference rate) of the user's profile is calculated based on the view frequency and view time which are obtained from the view history 102 for the extracted words.

The user profile may include the program title, type, performer name and keywords favored by the user which are inputted by the user.

The profile memory 104 saves profiles generated by the user profiler 103 in a time series one by one in a primary storage such as a memory. User profiles which were saved incrementally based on time information in the user profiles are summed for predetermined periods, and total profile information is thereby generated. The total profile information including period information is also saved. Total profile information for which the period information has exceeded a fixed period from the current time is moved to the total profile memory 105.

The total profile memory 105 saves the total profile information stored by the profile memory 104 for which the period information has exceeded the fixed period.

The timer 106 acquires the current time, and notifies the profile memory 104 or total profile memory 105 of when the predetermined period has elapsed by a real-time clock or an alarm built into the computer.

The profile manager/controller 107 controls the data flow between the user profiler 103, profile memory 104, total profile memory 105 and timer 106.

First, the method of calculating the profile strength (preference rate) will be described. The preference rate may be determined by the usual methods, i.e., by evaluating the length of total program view time, by calculating the ratio of program transmission time to total view time, or by using an operation (for example, channel changing) and the frequency with which it is performed while viewing, but in this embodiment, the calculation method will be described using the view history and the ratio of intermittent view time to the program transmission time obtained from the program information. The user's preference rate is calculated by the following equation:
Equation 1:

$$S = {\sum }_{i = 1}^{m} {( Ti \text{/} Tp )}^{n}$$

where, n>1.

Here, Tp is the transmission time of program P, and Ti is the i-th view time when the program was viewed intermittently on m occasions. In the actual calculation, the result is multiplied by correction factors when a distinction is made between viewing and recording, according to the type of recording (manual recording or automatic recording by inputting a keyword), or when a weighting is applied depending on whether playback is performed and how. Specifically, the weighting applied during the calculation of preference rate assigns a stronger profile to programs which the user meant to record than those recorded automatically, to recorded programs which were played back than those which were not, and to programs played back at normal speed than to those played back at high speed. By applying this weighting, the effect of the type of user operation on the profile can be taken into consideration so that a more realistic preference rate can be calculated.

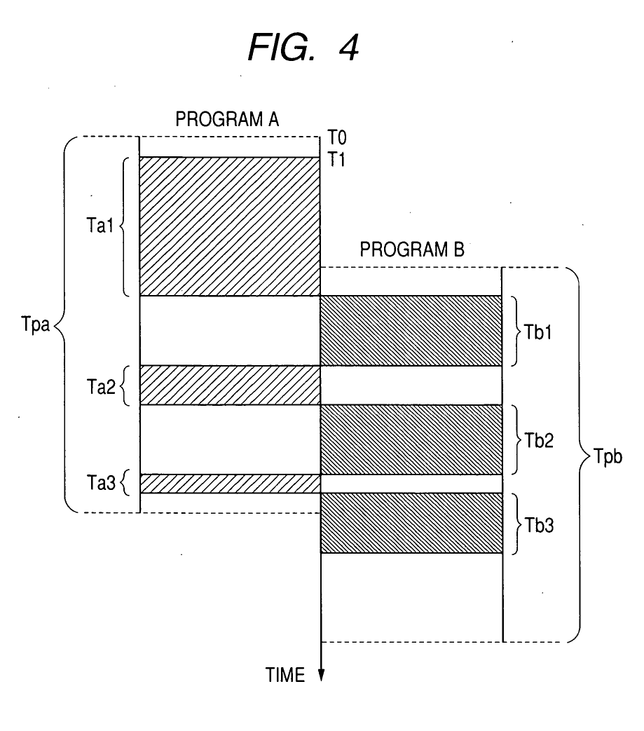

This will be described in more detail using FIG. 4. FIG. 4 is a diagram showing an example of the user's view history 102 when a user views a program A transmitted at a time T0 for Ta1 minutes from a time T1, views a program B for Tb1 minutes, views the program A for Ta2 minutes, views the program B for Tb2 minutes, views the program A for Ta3 minutes, and views the program B for Tb3 minutes. Suppose the transmission time for program A, i.e., the time from transmission start time to transmission end time, is Tpa and that for program B is Tpb. A preference rate Sa of a word extracted from the program information for program A is calculated by the following equation:
Sₐ=α((Tₐ₁/Tₚₐ)ⁿ+(Tₐ₂/Tₚₐ)ⁿ+(Tₐ₃/Tₚₐ)ⁿ) Equation 2
Here, α is a correction coefficient and n is a number larger than 1. A preference rate Sb of a word likewise extracted from program B is calculated by the following equation:
S_{b}=α((T_{b1}/T_{pb})ⁿ+(T_{b2}/T_{pb})ⁿ+(T_{b3}/T_{pb})ⁿ) Equation 3

Let the value of α and n be the same as in Equation 2. Here, Equation 2 and Equation 3 are calculation equations when Equation 1 is applied to the calculation of the preference rates Sa, Sb. In the view history of FIG. 4, assume that the transmission times of program A and program B are equal, i.e., Tpa=Tpb and that the view times of program A and program B are equal, i.e., Ta1+Ta2+Ta3=Tb1+Tb2+Tb3. Ta1, which is the maximum value of the partial view times Ta1, Ta2, Ta3 of program A, is a larger value than Tb1, which is the maximum value of Tb1, Tb2, Tb3 of program B, and the preference rate Sa calculated by Equation 2 is larger than the preference rate Sb calculated by Equation 3.

For example, assume that program A and program B are both 30 minute programs, Ta1 is 10 minutes, Ta2 is 4 minutes, Ta3 is 1 minute, i.e., a total of 15 minutes, whereas Tb1, Tb2, Tb3 are respectively 5 minutes, i.e., a total of 15 minutes. If the correction coefficients at this time were α=1 and n=2, Sa=0.128 and Sb=0.083 (to 3 decimal places), and the preference rate of program A is determined to be higher than that of program B.

If the sum of intermittent view times is the view time, and the preference rate is calculated without taking the intermittent view times into consideration, i.e., when it is calculated by the following equation, then if the total view time is the same, the preference rate will be the same even if the individual view times are different, i.e., Equation 4:

$$S = {( ( {\sum }_{i = 1}^{m} Ti ) \text{/} Tp )}^{n}$$

where, n>1.

In the method of calculating preference rate according to the invention, even if programs with the same transmission times are viewed for the same time, the preference rate of programs with a long partial view time is higher, so the user's preference rate's can be reflected more precisely. In particular, the preference rate of a user who repeatedly performs zapping (i.e., who often changes the channel) can be expressed precisely.

FIG. 4 showed an example where program A and program B had different start times and the programs had the same length, but the aforesaid equations for calculating preference rate may be applied regardless of start time, program length or how many programs overlap.

Next, the profile management method according to the invention will be described. The user profiler 103 applies Equation 1 to each program, and extracts a profile as a preference rate for words contained in the program information. The profile memory 104 saves the profiles extracted by the user profiler 103 incrementally in a time series.

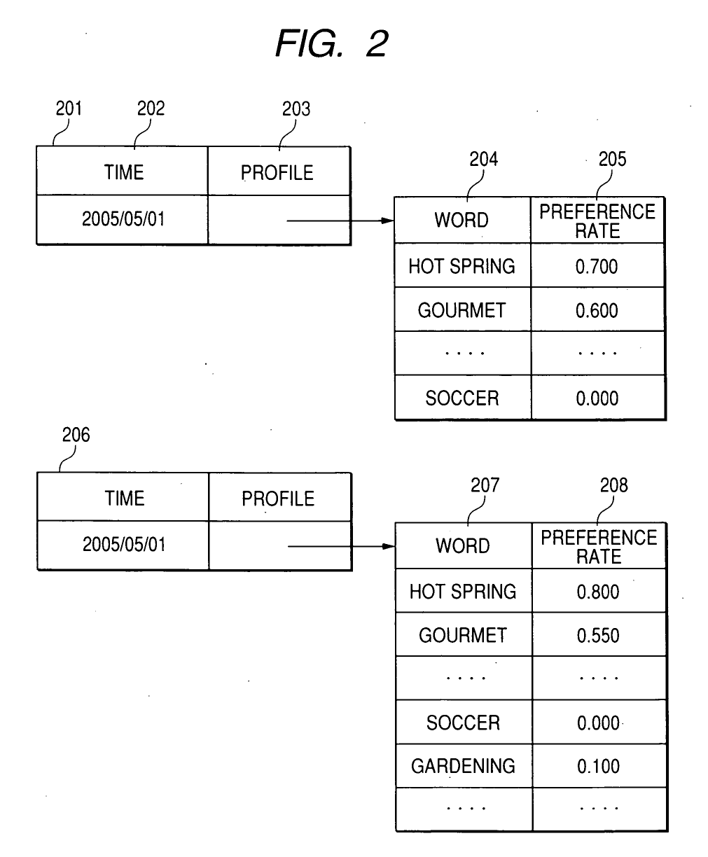

FIG. 2 is a diagram showing an example of a table in which the profile memory 104 manages the profiles generated by the user profiler 103. Profile information 201 comprises time information 202 and a profile 203. The profile information 201 comprises one or more sets of words 204 extracted from the program information 101, and preference rates 205 of the words. The time information 202 is information about the time when profiles started to be saved in this table. In other words, this is the start time and end time of the program obtained from the program information 101. It may also be the program view start time and view end time obtained from the view or recording history. In this case, priority is given to the period and time for which the user actually viewed a program over the program transmission period and time defined by the program editor. For example, when a user records a program with summer-oriented content which was transmitted in spring, and actually views it in summer, in applications where the programs viewed are mostly recorded programs, the view start and end time are deemed suitable from the viewpoint of reflecting the user's profile.

The word 204 of the profile 203 is a word extracted from information about transmitted programs from save start to the current time, and the preference rate 205 is a value calculated incrementally by calculating the sum or product of the preference rate for the word found by, for example, Equation 1 for each program and normalizing for each program. When the view history does not exist, the word is extracted from the program information. The preference rate of the word can also be set to 0 and registered in the profile. Here, assume that the profile information 201 is the state at time T1, and the profile information 206 is the state at a time T2 after T1. For a word which is already registered in the profile at time T1, the preference rate is updated. The preference rate 208 of the profile of FIG. 2 is a value which reflects the user profile extracted from time T1 to time T2. For example, at time T1, the preference rate for “hot spring” was 0.7, but at time T2 it is 0.8. Likewise, at time T1, the preference rate for “gourmet” was 0.6, but at time T2 it is 0.55. The preference rate of “soccer” is still 0. If a new word which does not exist in the words 204 of the profile of the profile 201 up to the time T1, is extracted from time T1 to T2, the new word is added to the word information 206 of the profile which becomes word information 207. For example, in FIG. 2, “gardening” is added. By storing words uniquely, the user memory can be employed efficiently.

The profile memory 104 saves profiles having the layout shown in FIG. 2 which were generated by the user profiler 103 in a primary storage device, such as a memory. The profile memory 104 generates total profile information which is summed for predetermined periods according to time information in the profiles. The total profile information including period information is saved in the primary storage device, such as a memory.

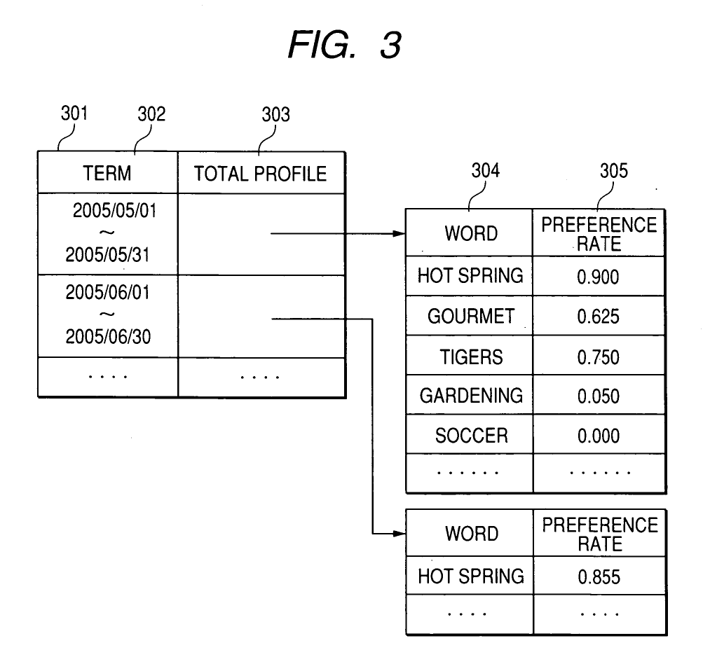

FIG. 3 is a diagram showing an example of total profile information. The total profile information 301 comprises period information 302 and a total profile 303. The period information 302 can register the total start time and total end time of the total profile information 301 which was summed at the predetermined periods, and this is made to correspond with the profiles. Hence, by performing summation management of profile at predetermined periods, the user's profile in a certain period can be computed precisely. In other words, profile elements which are highly seasonal in nature can be collected with good precision. Moreover, by managing profiles in relatively simple units, old profiles can be erased or moved between different media easily. This allows profile management which makes effective use of the memory.

The total profile 303 which constitutes the total profile information is generated by summing the profiles 203 of the profile information 201 saved by the profile memory 104 when a fixed time from the time information 202 has elapsed. In this case also, a profile corresponding to this time information in the period information, is calculated from the preference rate for words incrementally. In other words, values calculated by normalizing the sum or product of the summed respective profiles, are registered. In the example of the total profile of FIG. 3, the predetermined time is one month. Alternatively, total start and end dates such as 1 May, 2005 to 31 May, 2005 (hereafter, May 2005), or 1 Jun. to 30 Jun., 2005 (hereafter, June 2005), are registered as period information. The total profile corresponding to the period information May, 2005 is the profile information 201 which was saved incrementally from 00:00 on May 1, 2005 to 24:00 on May 31, 2005. It will be understood that periods divided by a predetermined grouping can of course be set arbitrarily.

In the user profiler of the invention, when there is a notice from the timer 106 that a fixed time has elapsed, a word for which the preference rate is no different from its initial value when summation starts, is extracted from the total profile of the total profile information when the notice is given, and this word can also be deleted from the total profile or moved to another storage area together with its preference rate in the total profile. Regarding information for which the preference rate used as a negative example in the latest user profile has not changed from its initial value, the value of using it as a negative example decreases after a fixed time has elapsed. Hence, by deleting information for which the preference rate still has its initial value, the precision of the profile can be maintained and the memory can be used effectively. This is true not only when the preference rate still has its initial value, but also when its variation amount does not exceed a threshold. In this way, information for which the user profile seldom changes can also be selected for deletion or movement, and the memory can be used effectively. Of course, the start point of the fixed time is not necessarily the start of the total time, and may be a certain time after the start of the total time, i.e., a certain time in the profile, it being possible to set any desired time.

For example, if the initial value of the preference rate was 0 in the total profile of FIG. 3, since the preference rate of soccer which is registered as a word in the total profile of the total profile information having the period information May, 2005 is 0, this word is deleted. The memory area which the profile of the eliminated word occupied, is thus released for the profile of a new word. Alternatively, instead of deleting it, the word may be moved to another economical storage area, e.g., a secondary memory storage such as for example a disk. When the profile of a word for which the preference rate is 0, is moved to another storage area, it can be re-used as a negative example, for example when making a program recommendation using the total profile information.

Hence, the total profile can be managed while paying attention to the change in preference rate of words after a fixed time has elapsed, and it can also be updated regularly for each predetermined period as follows.

When the difference between the total start time or total end time registered in the period information in the total profile information and the current time obtained from the timer 106, exceeds a predetermined time, the total profile memory 105 saves the target total profile in a secondary memory storage such as a disk, and deletes the total profile information from the profile memory 104. By placing information close to the current time in the memory, the user's latest profile can easily be looked up. As described later, in the example, it was assumed that program recommendations were made using the total profile information, but a program corresponding to the latest user's profile can be recommended by using a profile close to the current time, and the memory can also be used effectively.

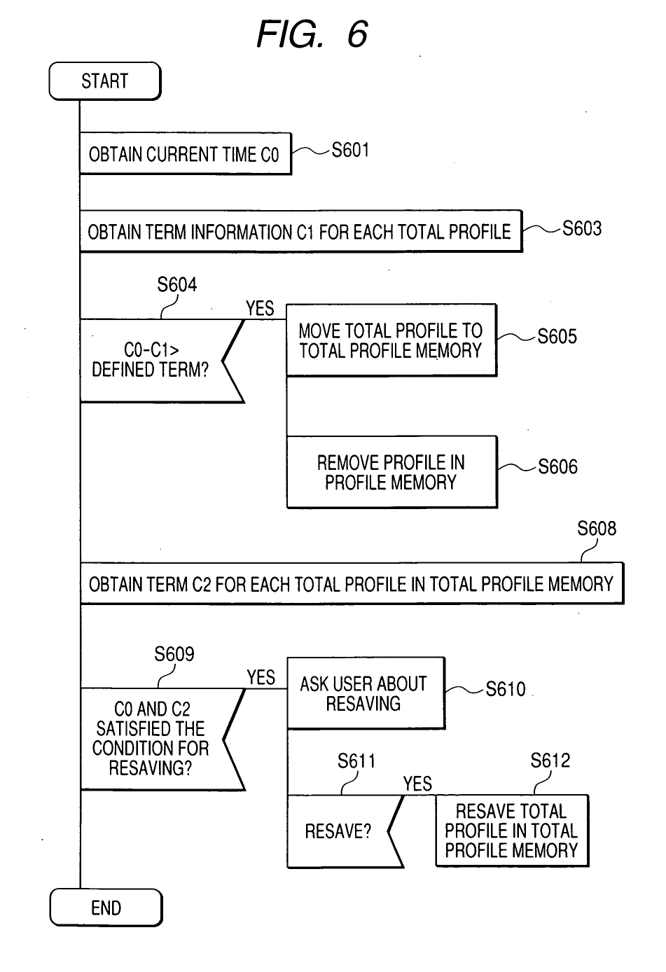

FIG. 6 is a PAD diagram showing the flow of save processing of total profile information. The saving of total profile information in the total profile memory 105, which is one of the features of the user profiler of the invention, and its re-save in the profile memory, will now be described using FIG. 6.

Hereafter, the case will be described where, in the total profile information shown in FIG. 3, the defined period is set as 3 months. In this embodiment where one month is taken as a unit, the specification of 3 months means storing a maximum of 3 groups of total profile information in the profile memory.

First, a current time C0 is acquired (S601). Now, suppose that the acquired current time was 00:00 on Aug. 1, 2005. Next, for each of the total profiles which were grouped and saved in the profile memory 104, the following processing is performed. A period information C1 of the total profile information is acquired (S603). Next, it is determined whether or not C0 and C1 exceed the defined period (S604). When the result is that the defined period was exceeded, the total profile information which has the corresponding period information C1 is saved by the total profile memory 105 (S605), and is deleted from the profile memory 104 (S606). For example, in the example of FIG. 3, it is determined that the total profile information in the period information May, 2005 exceeds the defined period of 3 months for the current time of 00:00 on 1 Aug., 2005, so it is saved in the total profile memory 105 and deleted from the profile memory 104.

Next, re-save of the total profile information saved by the total profile memory 105 will be described. For the total profile information saved in the total profile memory 105, the following processing is performed. A period information C2 for the total profile information saved in the total profile memory, is acquired (S608). It is determined whether or not the period information of the current time C0 obtained from the timer 106 and the period information C2 satisfy predetermined re-save conditions (S609), and if they do satisfy the predetermined re-save conditions, the target total profile information is re-saved in the profile memory (S612). For example, if the re-save conditions are defined as “the difference between the current time and the time registered in the period information of the total profile is a multiple of 1 year”, since the current time is 00:00 on Aug. 1, 2005, the period information of the total profile for August, 2004 and August, 2003, which is saved by the total profile memory 105, matches this condition, and it is therefore re-saved in the profile memory 104. Hence, not only current but past profiles for a certain specific period can be looked up. Due to this, the user profile for a profile element which is transmitted only at a certain specific time, such as a sport which is highly seasonal in nature, can be extracted precisely.

If the total profile information for the period August, 2004, and total profile information for the period August, 2003, are saved in the total profile memory 105, this total profile information may also be saved in the profile memory 104 after further summation. The summation may be performed by the profile summation method in the profile memory 104. Alternatively, only the latest information, which in the aforesaid example is the total profile information for August, 2004, may be saved. By selecting whether to use also the old information or only new information according to the rate of profile change, a more precise profile can be acquired.

Instead of specifying to re-save data by its relation with the current time as described above, total profile information for which the user directly defined a specific period in month units, for example July or September, 2004, may be selected for re-save. Thereby, the user can refer to past history, e.g., according to the season, without being affected by the current time.

When data from the total profile memory 105 is re-saved in the profile memory 104, the user may be asked whether or not to re-save the data via the interface unit 108 (S610, S611). Since the user can refuse to re-save when the user's profile changes or the profile before a fixed time differs from the current time, there is no risk of looking up erroneous profile from the memory.

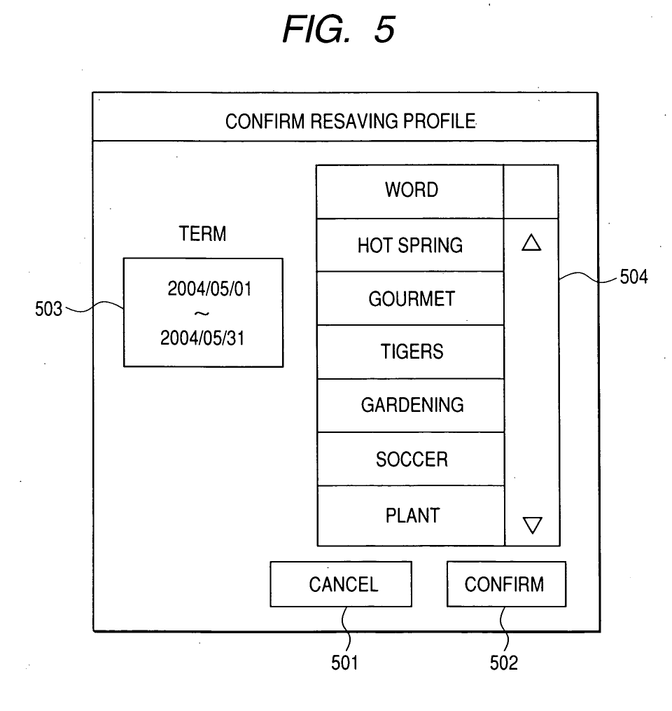

FIG. 5 is a diagram showing an example of a screen which asks the user whether or not to perform re-save. A list of words registered in the total profile of the total profile information is displayed. The user, by means of remote control, a mouse or a keyboard, checks a list 504 of the profiles to be re-saved, and either specifies “Confirm” 502 to re-save the data in the profile memory 104 (S612), or “Cancel” 501. He may also elect not to perform re-save. A re-save period information 503 is period information for the total profile information which was confirmed for re-save.

If the looked-up words differ substantially from his current profile, the user can extract a profile adapted more closely to the current user state by not performing re-save. Also, if they are close to his current profile, the user, by re-saving the profile, can suppress generation of erroneous profiles for programs which are not easily viewed. The user can select words he wishes to re-save from the list of words, and re-save only the selected words. By selecting the words to be re-saved, a more precise profile is obtained.

As described above, the user profiler of the invention, by saving and using profiles for different groups, can respond to profile changes easily. Also, since the memory can be used efficiently and the seasonal dependency of profiles can be reflected in user profiling, the user profiles can be extracted appropriately. By computing the preference rate taking account of profile continuity, the profiling precision can be further enhanced.

Finally, an example of a program recommendation using the total profile information saved by the profile memory 104 will be described. The total profile information grouped into fixed periods of, for example, one month collected over a fixed period of, for example, several months, which was re-saved from the total profile memory 105 and for which the period matches the current period, is saved in the profile memory. If the total profile information for the period which matches the current period is for several years, periodic profiles can be used while suppressing the usage storage area. The number of years to save the total profile information can be set by the user.

This total profile information comprises sets of words and their preference rates, respectively. The total profile information saved in the memory is integrated, and an integrated profile is thereby generated. Integrated preference rates of words are calculated from all sets of words in the total profile information saved in the memory. For example, the integrated preference rate of a certain word can be calculated by the linear sum of the preference rates of the word in each total profile information. In the calculation, the weighting factor of the total profile information which matches the period may be increased, or for total profile information saved in a fixed period, the weighting factor of new information may be increased. Due to this, profiles for matching periods or profiles for a period close to the current time, can be reflected strongly.

When recommending a program, the integrated profile information calculated above is used. The integrated profile information is compared with the program information, and a program which matches the user profile is recommended. Specifically, a morphological analysis is performed on program information which determines whether or not to recommend a program, and words in the program information are extracted. The programs to be recommended are those in a range from which the program information is obtained, i.e., programs which are currently being televised or which are scheduled to be televised. The preference rate of an extracted word can be calculated by looking up the integrated profile, and the program for which the sum of preference rates of all the words in the recommended program information is a maximum, is recommended. Alternatively, a threshold value of the preference rate may be set beforehand, and a program for which the sum of preference rates of words extracted from the recommended program information exceeds the threshold value, is recommended. Alternatively, attention can be focused on the preference rate of a word having the maximum preference rate among the words in the recommended program information, and a program for which this preference rate is a maximum or for which the threshold value is exceeded, is recommended. The number of programs to recommend may of course be specified, and a program recommended by selecting programs in order of preference rate from among plural programs exceeding the threshold value which are candidates for recommendation.

Due to this construction, a profile relevant to the current period may be selectively used from among the total profiles which are extracted with high precision and saved for every fixed period, or a program recommendation matching the user's profile can be performed.

The following advantages are obtained by implementing the invention shown above:
(1) A profile whose period is close to the current period or which matches a period, is extracted, and programs with profile elements having a high seasonal dependency can be recommended to the user using this profile.
(2) A precise preference rate which takes account of intermittent view time can be extracted.

The invention may be applied to domestic video devices such as DVD recorders and TVs, personal computers with TV functions, information devices such as PDA or mobile phones, and set top boxes which play back net distribution programs.

What is claimed is:

1. A user profiler, comprising:
a timer which acquires time information;
a user profiler which extracts a user profile from program information and program view history information; and
a profile memory which saves said profile,
wherein:
said memory saves said profiles one by one using said time information, and total profile information for predetermined periods is generated by summing said profiles for each predetermined period.

2. The user profiler according to claim 1, further comprising:
a total profile memory which saves said total profile information,
wherein, when a difference between a start of said period or an end of said period and a current time set exceeds said predetermined period, said profile memory moves said total profile information to said total profile memory.

3. The user profiler according to claim 2, wherein said profile memory reads said total profile information for a predetermined specific period from said total profile memory, and performs re-save based on said information for said current time.

4. The user profiler according to claim 2, wherein said profile memory deletes a word for which said preference rate in said total profile information does not change for a fixed time, or moves it to another storage area.

5. The user profiler according to claim 3, wherein said profile memory generates an integrated profile from said total profile information and said re-saved total profile saved in this profile memory, and makes a recommendation using this integrated profile and said program information.

6. A user profiler which performs user profiling based on program information and a user view history information, comprising:
a user profiler which extracts a user profile from said program information and said view history information; and
a profile memory which saves this user profile,
wherein:
said user profiler computes a preference rate using a ratio of intermittent view times for each program to the transmission time of said program; and
said profile memory saves said preference rate as said profile.
